(19) United States
(12) Patent Application Publication
(10) Pub. No.: US 2023/0199420 A1
(43) Pub. Date: Jun. 22, 2023

(54) REAL-WORLD ROOM ACOUSTICS, AND RENDERING VIRTUAL OBJECTS INTO A ROOM THAT PRODUCE VIRTUAL ACOUSTICS BASED ON REAL WORLD OBJECTS IN THE ROOM

(71) Applicant: Sony Interactive Entertainment Inc., Tokyo (JP)

(72) Inventors: Victoria Dorn, San Mateo, CA (US); Brandon Sangston, Foster City, CA (US)

(21) Appl. No.: 17/556,882

(22) Filed: Dec. 20, 2021

(51) Int. Cl. H04S 7/00; G06T 19/00

(52) U.S. Cl. CPC H04S 7/303; G06T 19/006; H04S 7/301; H04S 7/305; A63F 13/54; H04S 2400/11; H04S 2400/13; H04S 2400/15

(57) ABSTRACT

Methods and systems are provided for augmenting voice output of a virtual character in an augmented reality (AR) scene. The method includes examining, by a server, the AR scene, said AR scene includes a real-world space and the virtual character overlaid into the real-world space at a location, the real-world space includes a plurality of real-world objects present in the real-world space. The method includes processing, by the server, to identify an acoustics profile associated with the real-world space, said acoustics profile including reflective sound and absorbed sound associated with real-world objects proximate to the location of the virtual character. The method includes processing, by the server, the voice output by the virtual character while interacting in the AR scene; the processing is configured to augment the voice output based on the acoustics profile of the real-world space, the augmented voice output being audible by an AR user viewing the virtual character in the real-world space. In this way, when the voice output of the virtual character is augmented, the augmented voice output may sound more realistic to the AR user as if the virtual character is physically present in the same real-world space as the AR user.

### 1. FIELD OF THE DISCLOSURE

The present disclosure relates generally to augmented reality (AR) scenes, and more particularly to methods and systems for augmenting voice output of virtual objects in AR scenes based on an acoustics profile of a real-world space.

### BACKGROUND

### 2. Description of the Related Art

Augmented reality (AR) technology has seen unprecedented growth over the years and is expected to continue growing at a compound annual growth rate. AR technology is an interactive three-dimensional (3D) experience that combines a view of the real-world with computer-generated elements (e.g., virtual objects) in real-time. In AR simulations, the real-world is infused with virtual objects and provides an interactive experience. With the rise in popularity of AR technology, various industries have implemented AR technology to enhance the user experience. Some of the industries include, for example, the video game industry, entertainment, and social media.

For example, a growing trend in the video game industry is to improve the gaming experiencing of users by enhancing the audio in video games so that the gaming experience can be elevated in several ways such as by providing situational awareness, creating a three-dimensional audio perception experience, creating a visceral emotional response, intensifying gameplay actions, etc. Unfortunately, some AR users may find that current AR technology that is used in gaming is limited and may not provide AR users with an immersive AR experience when interacting with virtual characters and virtual objects in the AR environment. Consequently, an AR user may be missing an entire dimension of an engaging gaming experience.

It is in this context that implementations of the disclosure arise.

### SUMMARY

Implements of the present disclosure include methods, systems, and devices relating to augmenting voice output of a virtual object in an augmented reality (AR) scene. In some embodiments, methods are disclosed that enable augmenting the voice output of virtual objects (e.g., virtual characters) in an AR scene where the voice output is augmented based on the acoustic profile of a real-world space. For example, a user may be physically located in their living room and wearing AR goggles (e.g., AR head mounted display) to interact in an AR environment. While immersed in the AR environment that includes both real-world objects and virtual objects, the virtual objects (e.g., virtual characters, virtual pet, virtual furniture, virtual toys, etc.) may generate voice outputs and sound outputs while interacting in the AR scene. To enhance the sound output of the virtual objects so that it sounds more realistic to the AR user, the system may be configured to process the sound output based on the acoustics profile of the living room.

In one embodiment, the system is configured to identify an acoustics profile associated with the real-world space of the AR user. Since the real-world space of the AR user may be different each time AR user initiates a session to engage with an AR scene, the acoustics profile may include different acoustic characteristics and depend on the location of the real-world space and the real-world objects that are present. Accordingly, the methods disclosed herein outline ways of augmenting the sound output of virtual objects based on the acoustics profile of the real-world space. In this way, the sound output of the virtual objects may sound more realistic to the AR user in his or her real-world space as if the virtual objects are physically present in the same real-world space.

In some embodiments, the augmented sound output of the virtual objects can be audible via a device of the AR user (e.g., head phones or earbuds), via a local speaker in the real-world space, or via a surround sound system (e.g., 5.1-channel surround sound configuration, 7.1-channel surround sound configuration, etc.) that is present in the real-world space. In other embodiments, specific sound sources that are audible by the AR user can be eliminated and selectively removed based on the preferences of the AR user. For instance, if children are located in the real-world living room of the AR user, sound produced by the children can be removed and inaudible to the AR user. In other embodiments, sound components produced by specific virtual objects (e.g., barking virtual dog) can be removed so that it is inaudible to the AR user. In one embodiment, sound components originating from specific regions in the real-world space can be removed so that it is inaudible to the AR user. In this way, specific sound components can be selectively removed based on the preferences of the AR user to provide the AR user with a customized AR experience and to allow the AR user to be fully immersed in the AR environment.

In one embodiment, a method for augmenting voice output of a virtual character in an augmented reality (AR) scene is provided. The method includes examining, by a server, the AR scene, said AR scene includes a real-world space and the virtual character overlaid into the real-world space at a location, the real-world space includes a plurality of real-world objects present in the real-world space. The method includes processing, by the server, to identify an acoustics profile associated with the real-world space, said acoustics profile including reflective sound and absorbed sound associated with real-world objects proximate to the location of the virtual character. The method includes processing, by the server, the voice output by the virtual character while interacting in the AR scene; the processing is configured to augment the voice output based on the acoustics profile of the real-world space, the augmented voice output being audible by an AR user viewing the virtual character in the real-world space. In this way, when the voice output of the virtual character is augmented, the augmented voice output may sound more realistic to the AR user as if the virtual character is physically present in the same real-world space as the AR user.

In another embodiment, a system for augmenting sound output of a virtual object in an augmented reality (AR) scene is provided. The system includes an AR head mounted display (HMD), said AR HMD includes a display for rendering the AR scene. In one embodiment, said AR scene includes a real-world space and the virtual object overlaid into the real-world space at a location, the real-world space includes a plurality of real-world objects present in the real-world space. The system includes a processing unit associated with the AR HMD for identifying an acoustics profile associated with the real-world space, said acoustics profile including reflective sound and absorbed sound associated with real-world objects proximate to the location of the virtual object. In one embodiment, the processing unit is configured to process the sound output by the virtual object while interacting in the AR scene, said processing unit is configured to augment the sound output based on the acoustics profile of the real-world space; the augmented sound output being audible by an AR user viewing the virtual object in the real-world space.

Other aspects and advantages of the disclosure will become apparent from the following detailed description, taken in conjunction with the accompanying drawings, illustrating by way of example the principles of the disclosure.

### BRIEF DESCRIPTION OF THE DRAWINGS

The disclosure may be better understood by reference to the following description taken in conjunction with the accompanying drawings in which:

FIG. 1 illustrates an embodiment of a system for interaction with an augmented reality environment via an AR head-mounted display (HMD), in accordance with an implementation of the disclosure.

FIG. 2 illustrates an embodiment of an AR user in a real-world space and an illustration of an acoustics profile of the real-world space which includes reflective sound and absorbed sound associated with real-world objects, in accordance with an implementation of the disclosure.

FIG. 3 illustrates an embodiment of a system that is configured to process sound output of virtual objects and to augment the sound output based on an acoustics profile of a real-world space, in accordance with an implementation of the disclosure.

FIG. 4 illustrates an embodiment of a system for augmenting sound output of virtual objects in an AR scene using an acoustics profile model, in accordance with an implementation of the disclosure.

FIG. 5 illustrates an embodiment of an acoustics properties table illustrating an example list of materials and its corresponding sound absorption coefficient, in accordance with an implementation of the disclosure.

FIG. 6 illustrates components of an example device that can be used to perform aspects of the various embodiments of the present disclosure.

### DETAILED DESCRIPTION

The following implementations of the present disclosure provide methods, systems, and devices for augmenting voice output of a virtual character in an augmented reality (AR) scene for an AR user interacting in an AR environment. In one embodiment, the voice output by the virtual character can be augmented based on an acoustics profile of the real-world space where the AR user is present. In some embodiments, the acoustics profile of the real-world space may vary and have acoustic characteristics (e.g., reflective sound, absorbed sound, etc.) that are based on the location of the real-world space and the real-world objects that are present in the real-world space. Accordingly, the system is configured to identify the acoustics profile of the real-world space where a given AR user is physically located and to augment the voice output of the virtual characters based on the identified acoustics profile.

For example, an AR user may be interacting with an AR scene that includes the AR user physically located in a real-world living room while watching a sporting event on television. While watching the sporting event, virtual characters can be rendered in the AR scene so that the AR user and virtual characters can watch the event together. As the virtual characters and the AR user converse with one another, the system is configured to identify an acoustic profile of the living room and to augment the voice output of the virtual characters which can be audible to the AR user in substantial real-time. Accordingly, as the voice output of the virtual characters are augmented and delivered to the AR user, this enables an enhanced and improved AR experience for the AR user since the augmented voice output of the virtual characters may sound more realistic as if the virtual characters are physically present in the same real-world space as the AR user. This allows the AR user to have a more engaging and intimate AR experience with friends who may appear in the real-world space as virtual characters even though they may be physically located hundreds of miles away. In turn, this can enhance the AR experience for AR users who desire to have realistic social interactions with virtual objects and virtual characters.

By way of example, in one embodiment, a method is disclosed that enables augmenting voice output of a virtual character in an AR scene. The method includes examining, by a server, the AR scene, the AR scene includes a real-world space and the virtual character overlaid into the real-world space at a location. In one example, the real-world space includes a plurality of real-world objects present in the real-world space. In one embodiment, the method may further include processing, by the server, to identify an acoustics profile associated with the real-world space. In one example, the acoustics profile includes reflective sound and absorbed sound associated with real-world objects proximate to the location of the virtual character. In another embodiment, the method may include processing, by the server, the voice output by the virtual character while interacting in the AR scene. In one example, the processing of the voice output is configured to augment the voice output based on the acoustics profile of the real-world space. The augmented voice output can be audible by an AR user viewing the virtual character in the real-world space.

In accordance with one embodiment, a system is disclosed for augmenting sound output (e.g., voice output) of virtual objects (e.g., virtual characters) that are present in an AR scene. For example, a user may be using AR head mounted display (e.g., AR goggles. AR glasses, etc.) to interact in an AR environment which includes various AR scenes generated by a cloud computing and gaming system. While viewing and interacting with the AR scenes through the display of the AR HMD, the system is configured to analyze the field of view (FOV) into the AR scene and to examine the real-world space to identify real-world objects that may be present in the real-world space. In one embodiment, the system is configured to identify an acoustics profile associated with the real-world space which may include reflective sound and absorbed sound associated with the real-world objects. In some embodiments, if the AR scene includes virtual characters that produce voice output, the system is configured to augment the voice output based on the acoustics profile of the real-world space. In this way, the augmented voice output may sound more realistic and provide the AR user with an enhanced and improved AR experience.

With the above overview in mind, the following provides several example figures to facilitate understanding of the example embodiments.

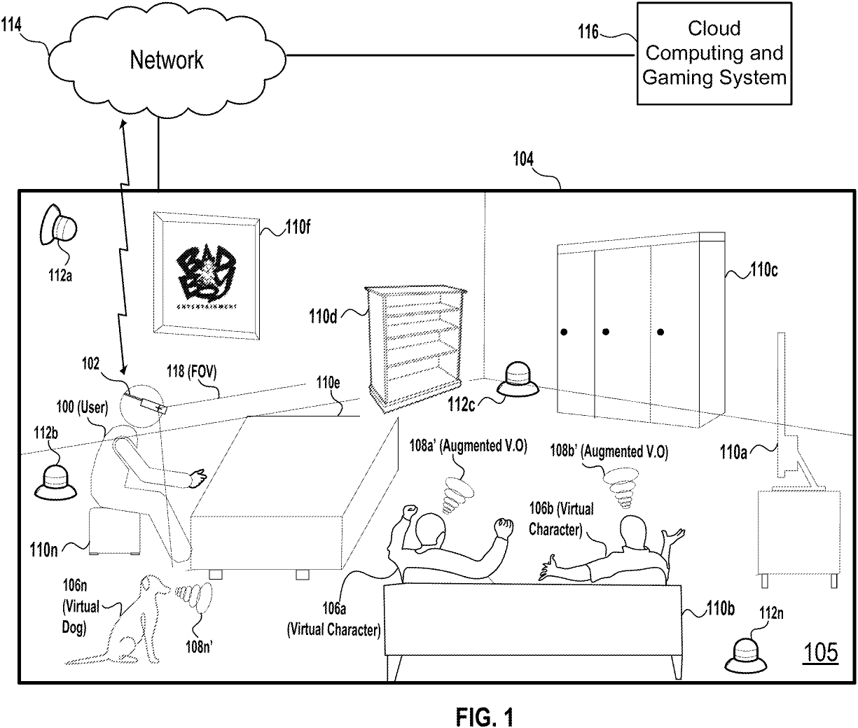

FIG. 1 illustrates an embodiment of a system for interaction with an augmented reality environment via an AR head-mounted display (HMD) 102, in accordance with implementations of the disclosure. As used herein, the term “augmented reality” generally refers to user interaction with an AR environment where a real-world environment is enhanced by computer-generated perceptual information (e.g., virtual objects). An AR environment may include both real-world objects and virtual objects where the virtual objects are overlaid into the real-world environment to enhance the experience of a user 100. In one embodiment, the AR scenes of an AR environment can be viewed through a display of a device such as an AR HMD, mobile phone, or any other device in a manner that is responsive in real-time to the movements of the AR HMD (as controlled by the user) to provide the sensation to the user of being in the AR environment. For example, the user may see a three-dimensional (3D) view of the AR environment when facing in a given direction, and when the user turns to a side and thereby turns the AR HMD likewise, and then the view to that side in the AR environment is rendered on the AR HMD.

As illustrated in FIG. 1, a user 100 is shown physically located in a real-world space 105 wearing an AR HMD 102 to interact with virtual objects 106a-1068n that are rendered in an AR scene 104 of the AR environment. In one embodiment, the AR HMD 102 is worn in a manner similar to glasses, goggles, or a helmet, and is configured to display AR scenes, video game content, or other content to the user 100. The AR HMD 102 provides a very immersive experience to the user by virtue of its provision of display mechanisms in close proximity to the user’s eyes. Thus, the AR HMD 102 can provide display regions to each of the user’s eyes which occupy large portions or even the entirety of the field of view of the user, and may also provide viewing with three-dimensional depth and perspective.

In some embodiments, the AR HMD 102 may include an externally facing camera that is configured to capture images of the real-world space 105 of the user 100 such as real-world objects 110 that may be located in the real-world space 105 of the user. In some embodiments, the images captured by the externally facing camera can be analyzed to determine the location/orientation of the real-world objects 110 relative to the AR HMD 102. Using the known location/orientation of the AR HMD 102, the real-world objects, and inertial sensor data from the AR HMD, the physical actions and movements of the user can be continuously monitored and tracked during the user’s interaction. In some embodiments, the externally facing camera can be an RGB-Depth sensing camera or a three-dimensional (3D) camera which includes depth sensing and texture sensing so that 3D models can be created. The RGB-Depth sensing camera can provide both color and dense depth images which can facilitate 3D mapping of the captured images. For example, the externally facing is configured to analyze the depth and texture of a real-world object such as coffee table that may be present in the real-world space of the user. Using the depth and texture data of the coffee table, the material and acoustic properties of the coffee table can be further determined. In other embodiments, the externally facing is configured to analyze the depth and texture of other real-world objects such as the walls, floors, carpet, etc. and their respective acoustic properties.

In some embodiments, the AR HMD 102 may provide a user with a field of view (FOV) 118 into the AR scene 104. Accordingly, as the user 100 turns their head and looks toward different regions within the real-world space 105, the AR scene is updated to include any additional virtual objects 106 and real-world objects 110 that may be within the FOV 118 of the user 100. In one embodiment, the AR HMD 102 may include a gaze tracking camera that is configured to capture images of the eyes of the user 100 to determine the gaze direction of the user 100 and the specific virtual objects 106 or real-world objects 110 that the user 100 is focused on. Accordingly, based on the FOV 118 and the gaze direction of the user 100, the system may detect specific objects that the user may be focused on, e.g., virtual objects, furniture, television, floors, walls, etc.

In the illustrated implementation, the AR HMD 102 is wirelessly connected to a cloud computing and gaming system 116 over a network 114. In one embodiment, the cloud computing and gaming system 116 maintains and executes the AR scenes and video game played by the user 100. In some embodiments, the cloud computing and gaming system 116 is configured to receive inputs from the AR HMD 102 over the network 114. The cloud computing and gaming system 116 is configured to process the inputs to affect the state of the AR scenes of the AR environment. The output from the executing AR scenes, such as virtual objects, real-world objects, video data, audio data, and user interaction data, is transmitted to the AR HMD 102. In other implementations, the AR HMD 102 may communicate with the cloud computing and gaming system 116 wirelessly through alternative mechanisms or channels such as a cellular network.

In the illustrated example shown in FIG. 1, the AR scene 104 includes an AR user 100 immersed in an AR environment where the AR user 100 is interacting with virtual objects (e.g., virtual character 106a, virtual character 106b, virtual dog 106n) while watching a sports event on television. In the example, the AR user 100 is physically located in a real-world space which includes a plurality of real-world objects 110a-110n and virtual objects that are rendered in the AR scene. In particular, real-world object 110a is a “television,” real-world object 110b is a “sofa,” real-world object 110c is a “storage cabinet,” real-world object 110d is a “bookshelf,” real-world object 110e is a “coffee table,” and real-world object 110f is a “picture frame.” In some embodiments, the virtual objects can be overlaid in a 3D format that is consistent with the real-world environment. For example, the virtual characters are rendered in the scene such that the size and shape of the virtual characters are scaled consistently with a size of the real-world sofa in the scene. In this way, when virtual objects and virtual characters appear in 3D in the AR scene, their respective size and shapes are consistent with the other objects in the scene so that they will appear proportional relative to their surroundings.

In one embodiment, the system is configured to identify an acoustics profile associated with the real-world space 105. In some embodiments, the acoustics profile may include reflective sound and absorbed sound associated with the real-world objects. For example, when a sound output is generated via a real-world object (e.g., audio from television) or a virtual object (e.g., barking from virtual dog) in the real-world space 105, the sound output may cause reflected sound to bounce off the real-world objects 110 (e.g., walls, floor, ceiling, furniture, etc.) that are present in the real-world space 105 before it reaches the ears of the AR user 100. In other embodiments, when a sound output is generated in the real-world space 105,acoustic absorption may occur where the sound output is received as absorbed sound by which the real-world object takes in the sound energy as opposed to reflecting it as reflective sound. In one embodiment, reflective sound and absorbed sound can be determined based on the absorption coefficients of the real-world objects 110. In general, soft, pliable, or porous materials (like cloths) may absorb more sound compared to dense, hard, impenetrable materials (such as metals). In some embodiments, the real-world objects may have reflective sound and absorbed sound where the reflective sound and absorbed sound includes a corresponding magnitude that is based on the location of sound output in the real-world space and its sound intensity. In other embodiments, the reflective sound and absorbed sound associated with the real-world objects are proximate to the location of the virtual object or real-world object that projects the sound output.

As further illustrated in FIG. 1, the AR scene 104 includes virtual objects 106a-106n that are rendered in the AR scene 104. In particular, virtual objects 106a-106b are “virtual characters,” and virtual object 106n is a “virtual dog.” In one embodiment, the virtual objects 106a-106n can produce various sound and voice outputs such as talking, singing, laughing, crying, screaming, shouting, yelling, grunting, barking, etc. For example, while interacting and watching a sporting event with the AR user 100, the virtual characters may produce respective sound outputs such as voice outputs 108a-108b, e.g., chanting and cheering for their favorite team. In another example, a virtual dog may produce a sound output 108n such as the sound of a dog barking. In some embodiments, the sound and voice outputs of the virtual objects 106a-106n can be processed by the system.

Throughout the progression of the user’s interaction in the AR environment, the system can automatically detect the voice and sound outputs produced by the corresponding virtual objects and can determine its three-dimensional (3D) location in the AR scene. In one embodiment, using the identified acoustics profile of the real-world space 105, the system is configured to augment the sound and voice output based on the acoustics profile. As a result, when the augmented sound and voice outputs (e.g., 108a′-108n′) are perceived by the user, it may sound more realistic to the AR user 100 since the sound and voice outputs are augmented based on the acoustic characteristics of the real-world space 105.

As illustrated in the example shown in FIG. 1, the real-world space 105 may include a plurality of microphones or acoustic sensors 112 that can be placed at various positions within the real-world space 105. In one embodiment, the acoustic sensors 112 are configured to measure sound and vibration with high fidelity. For example, the acoustic sensors 112 can capture a variety of acoustic measurements such as frequency response, sound reflection levels, sound absorption levels, how long it takes for frequency energy to decay in the room, reverberations, echoes, etc. Using the noted acoustic measurements, an acoustic profile can be determined for specified location in the real-world space 105.

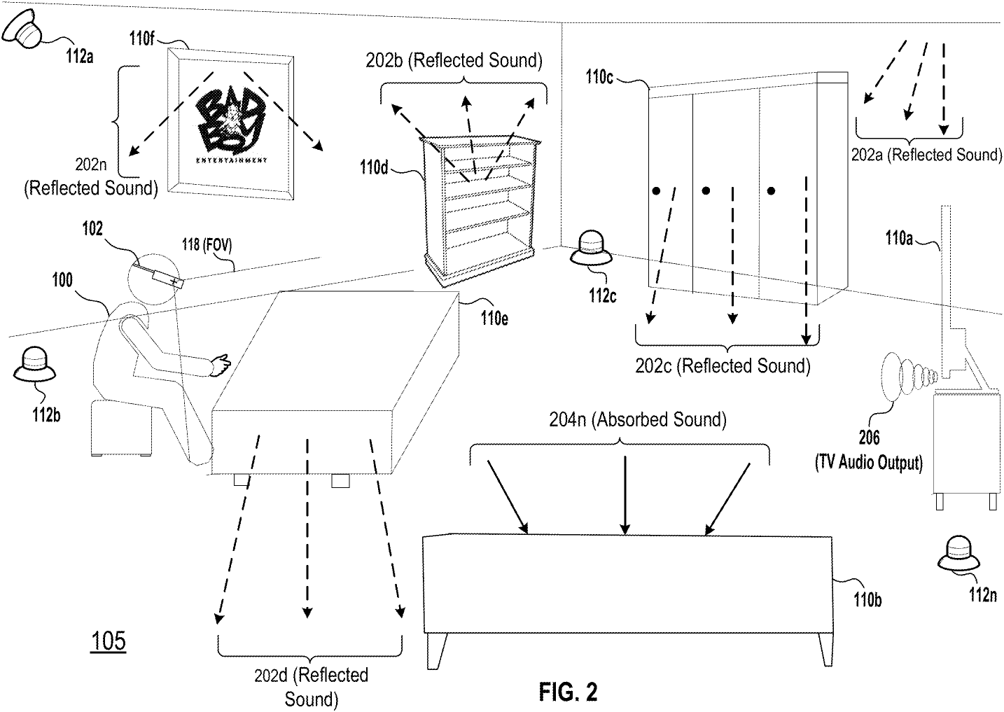

FIG. 2 illustrates an embodiment of an AR user 100 in a real-world space 105 and an exemplary illustration of an acoustics profile of the real-world space 105 which includes reflective sound and absorbed sound associated with real-world objects 110a-110n. As noted above, the real-world space 105 may include a plurality of real-world objects 110a-110n that are present in the real-world space, e.g., television, sofa, bookshelf, etc. In some embodiments, the system is configured to identify an acoustics profile associated with the real-world space 105 where the acoustics profile includes reflective sound and absorbed sound associated with real-world objects 110a-110n. For example, an echo is a reflective sound that can bounce off surfaces of the real-world objects. In another example, reverberation can be a collection of the reflective sounds in the real-world space 105. Since the acoustics profile may differ for each real-world space 105, the system may include a calibration process where acoustic sensors 112 or microphones of the AR HMD 102 can be used to determine the acoustic measurements of the real-world space 105 for generating an acoustics profile for a particular real-world space.

In one example, when a real-world object 110a (e.g., television) produces a sound output (e.g., TV audio output 206), the sound output may cause reflected sound 202a-202n to bounce off the real-world objects 110 (e.g., walls, floor, ceiling, furniture, etc.) that are present in the real-world space 105 before it reaches the ears of the AR user 100. In one embodiment, the reflected sound 202a-202n may have a corresponding magnitude and direction that corresponds to a sound intensity level of the sound output (e.g., TV audio output 206) produced in the real-world space. As shown in FIG. 2, reflected sound 202a is reflected off the wall of the real-world space, reflected sound 202b is reflected off the bookshelf, reflected sound 202c is reflected off the storage cabinet, reflected sound 202d is reflected off the coffee table, and reflected sound 202n is reflected off the picture frame. In some embodiments, the magnitude and direction and of the reflected sound 202a-202n may depend on the absorption coefficients of the respective real-world objects 110 and its shape and size. As further shown in FIG. 2, the sound output may cause acoustic absorption to occur where absorbed sound 204n is received by the sofa as opposed to reflecting it as reflective sound. In one embodiment, the absorbed sound 204n may include a magnitude and direction which may be based on the absorption coefficient of the sofa, the shape and size of the sofa, and sound intensity level of the sound output.

In one embodiment, the system is configured to examine the size and shape of the real-world objects 110 and its corresponding sound absorption coefficient to identify the acoustics profile of the real-world space 105. For example, the reflected sound 202a associated with the walls may have a greater magnitude than the reflective sound 202b associated with the bookshelf 110d since the walls have a greater surface area and a smaller sound absorption coefficient relative to the bookshelf 110d. Accordingly, the size, shape, and acoustic properties of the real-world objects can affect the acoustics profile of a real-world space 105 and in turn be used to augment the voice output of the virtual character in the real-world space.

In some embodiments, a calibration process can be performed using acoustic sensors 112 to determine the acoustics profile of the real-world space 105. As shown in FIG. 2, acoustic sensors 112 that can be placed at various positions within the real-world space 105. When a sound a sound output (e.g., TV audio output 204) is produced, the acoustic sensors 112 is configured to measure the acoustic characteristics at the location where the acoustic sensors are located and also within the surrounding proximity of the acoustic sensors. As noted above, the acoustic sensors 112 can be used to measure a variety of acoustic measurements such as frequency response, sound reflection levels, sound absorption levels, how long it takes for frequency energy to decay in the room, magnitude and direction and of the reflected sound, magnitude and direction and of the absorbed sound, etc. Based on the acoustic measurements, an acoustic profile can created for the real-world space which in turn can be used to augment the sound component of the virtual objects.

In other embodiments, a calibration process can be performed using the AR HMD 102 to determine the acoustics profile of the real-world space 105. In one example, the user 100 may be instructed to move around the real-world space 105 to test and measure the acoustics characteristics at different positions in the real-world space. In one embodiment, the user is instructed to stand a specific position in the real-world room and is prompted to verbally express a phrase (e.g., hello, how are you?). When the user 100 verbally expresses the phrase, microphones of the AR HMD 102 are configured to process the verbal phrase and to measure the acoustic characteristics of the area where the user 100 is located. In some embodiments, the microphones of the AR HMD 102 is configured to measure a variety of acoustic measurements such as frequency response, sound reflection levels, sound absorption levels, how long it takes for frequency energy to decay in the room, magnitude and direction and of the reflected sound, magnitude and direction and of the absorbed sound, reverberations, echoes, etc. Based on the acoustic measurements, the acoustics profile can be determined for the real-world space 105.

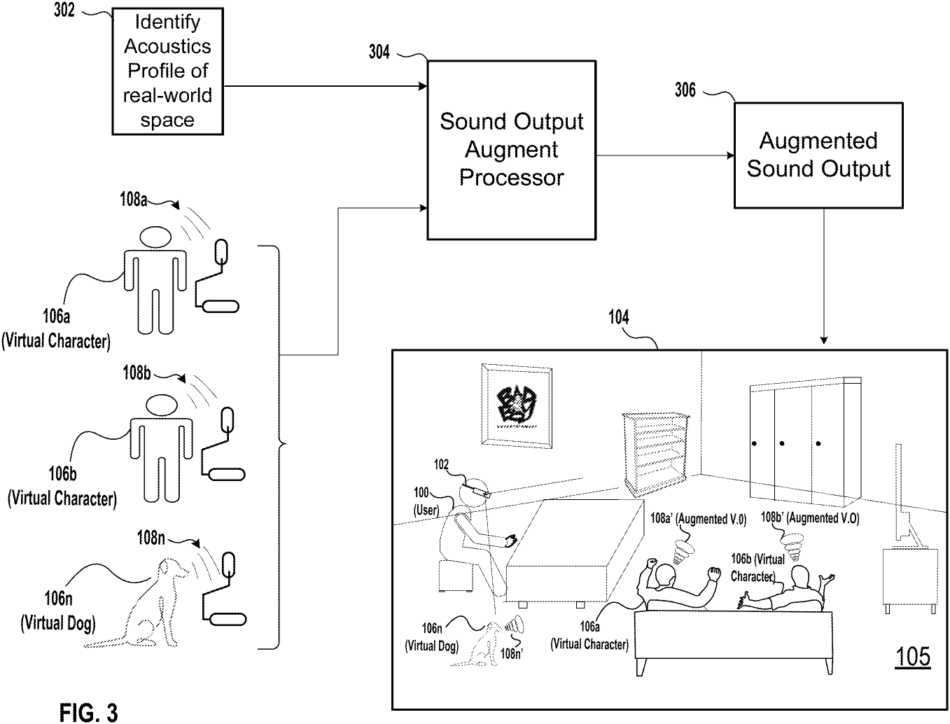

FIG. 3 illustrates an embodiment of a system that is configured to process sound output (e.g., voice output) 108-108n of virtual objects and to augment the sound output based on an acoustics profile of a real-world space 105 of a user 100. In one embodiment, when virtual objects 106a-106n are rendered in the AR scene 104, the system may include an operation that is configured to capture and process their respective sound output 108a-108n. For example, as shown in the AR scene 104, virtual objects 106a-106b representing virtual characters are shown sitting on a real-world sofa watching television and interacting with the AR user 100. As further illustrated, virtual object 106n representing a virtual dog is shown sitting next to the AR user 100. In one embodiment, the system can determine the 3D location of the virtual characters and the virtual dog in the real-world space 105 and their respective position relative to the AR user 100. In some embodiments, when the virtual objects 106a-106n produces sound output 108a-108n (e.g., talking, barking, etc.), the system is configured to augment the sound output 108a-108n based on the acoustics profile of the real-world space 105. After processing and augmenting the sound produced by the virtual objects, the augmented sound output 108a′-108n′ can be audible by the AR user 100 via the AR HMD 102 or surround sound speakers that may be present in the real-world space 105.

In other embodiments, the system is configured to process any sound or sound effect based on the acoustics profile of the real-world space 105 of the user 100. In this way, when the sound is augmented, the augmented sound may sound more realistic to the AR user as if the augmented sound is present in the same real-world space as the AR user.

In one embodiment, the system includes an operation 302 that is configured to identify an acoustics profile of a real-world space 105. In some embodiments, the operation may include a calibration process where acoustic sensors 112 are placed at various locations within the real-world space and configured to measure acoustic characteristics within its surrounding area. In one embodiment, operation 302 is configured to measure a variety of acoustic measurements such as frequency response, sound reflection levels, sound absorption levels, how long it takes for frequency energy to decay in the room, magnitude and direction and of the reflected sound, magnitude and direction and of the absorbed sound, reverberations, echoes, etc. Using the acoustic measurements, the acoustics profile the real-world space 105 can be identified and used to augment the respective sound output 108a-108n of the virtual characters. As noted above, the calibration process can also be performed using the AR HMD 102 to determine the acoustics profile of the real-world space 105. In one example, the user 100 may be instructed to move around the real-world space 105 to test and measure the acoustics characteristics at various locations in the real-world space. When the user is prompted to speak or to generate a sound output, the microphones of the AR HMD 102 are configured to capture the acoustic measurements which can be used generate the acoustics profile the real-world space 105.

As further illustrated in FIG. 3, the system may include a sound output augment processor 304 that is configured to augment the sound output 108a-108n of the virtual objects 106a-106n in substantial real-time. As illustrated, the sound output augment processor 304 is configured to receive the acoustics profile of the real-world space 105 and the sound output 108a-108n of the virtual objects 106a-106n. In one embodiment, the sound output augment processor 304 may use a machine learning model to identify various sound characteristics associated with the sound output 108a-108n. For example, the machine learning model can be used to distinguish between the sound outputs of the various virtual objects (e.g., virtual characters, virtual dog, virtual door, etc.) and the real-world objects (e.g., audio output from television). In other embodiments, the machine learning model can be used to determine sound characteristics such as an intensity level, emotion, mood, etc. associated with the sound output.

In some embodiments, the sound output augment processor 304 is configured to process the acoustics profile of the real-world space 105. Using the position coordinates of the virtual objects 106a-106n and their respective sound outputs 108a-108n, the sound output augment processor 304 is configured to augment the sound outputs 108a-108n based on the acoustics profile and the position of the virtual objects 106a-106n to generate augmented sound outputs 108a′-108n′ which can be audible by the AR user 100. For example, the acoustics profile of the real-world space 105 includes acoustic characteristics such as reflective sound 202 and absorbed sound 204 associated with the real-world objects 110a-110n in the room, e.g., walls, floors, ceiling, sofa, cabinet, bookshelf, television, etc. When the sound outputs 108a-108n are augmented to produce the augmented sound outputs 108a′-108n′, the augmented sound outputs 108a′-108n′ may appear more realistic to the user since the sound augment processor 304 takes into consideration the acoustic properties of the real-world objects and the location in the room where the sound output was projected by the virtual object.

In some embodiments, operation 306 is configured to transmit the augmented sound output 108a′-108n′ to the AR user 100 during the user’s interaction with the AR scene 104 which can be audible via an AR HMD 102. In other embodiments, the augmented sound output 108a′-108n′ can be transmitted to a surround sound system (e.g., 5.1-channel surround sound configuration, 7.1-channel surround sound configuration, etc.) in the real-world room 105. In some embodiments, when the augmented sound output 108a′-108n′ is delivered through the surround sound system, the surround sound system may provide a spatial relationship of the sound output produced by the virtual objects. For example, if a virtual character (e.g., 106a) is sitting in the corner of the real-world room 105 and is surrounded by windows, the augmented sound output may be perceived by the AR user 100 as sound being projected from the corner of the real-world room and the sound may appear as if it is reflected off of the windows. Accordingly, the augmented sound output 108a′-108n′ of the virtual objects may take into consideration the spatial relationship of the position of the virtual object relative to the AR user 100.

In some embodiments, operation 306 is configured to segment out specific types of sound sources from the augmented sound output 108a′-108n′. In one embodiment, operation 306 may remove various types of sounds, reflected sound, absorbed sound, and other types of sounds from the augmented sound output 108a′-108n′. In one embodiment, the segmentation enables the isolation of frequencies associated with the sound output and enable certain sounds to be selectively removed or added to the augmented sound output 108a′-108n′. In one example, operation 306 is configured to remove and eliminate specific sounds from the augmented sound output 108a′-108n′ so that it is inaudible to the user. For instance, if a television is located in the real-world living room of the AR user, sound produced by the television can be it may be removed from the augmented sound outputs so that it is inaudible to the AR user.

In other embodiments, the augmented sound outputs can be modified to remove specific sound components (e.g., virtual dog barking, children screaming, roommates talking, etc.) so that the selected sounds are inaudible to the AR user. In one embodiment, additional sounds can be added to the augmented sound outputs 108a′-108n′ to provide the user 100 with a customized AR experience. For example, if a virtual dog (e.g., 106n) barks, additional barking sounds can be added to the augmented sound output 108n′ to make it appear as if a pack of dogs are present in the real-world space. In other embodiments, sound components from specific regions in the real-world space can removed from the augmented sound outputs 108a′-108n′ so that it is inaudible to the AR user. In this way, specific sound components can be selectively removed to modify the augmented sound output and to provide the AR user with a customized experience. In other embodiments, operation 306 is configured to further customize the augmented sound outputs 108a′-108n′ by changing the tone, sound intensity, pitch, volume, and other characteristics based on the context of the AR environment. For example, if the virtual characters are watching a boxing fight and the boxer that they are cheering for is on the verge of winning the fight, the augmented sound output of the virtual characters may be adjusted to increase the sound intensity and volume so that it corresponds with what is occurring in the boxing fight. In another embodiment, operation 306 is configured to further customize the augmented sound outputs 108a′-108n′ by replacing the augmented sound outputs with an alternate sound or based on the preferences of the AR user. For example, if a virtual dog (e.g., 106n) barks, the barking sound can be translated or replaced with an alternate sound such as a cat meowing, a human speaking, etc. In another example, if the virtual object 106a speaks, the augmented sound output can be modified so that it sounds like the AR user’s favorite game character.

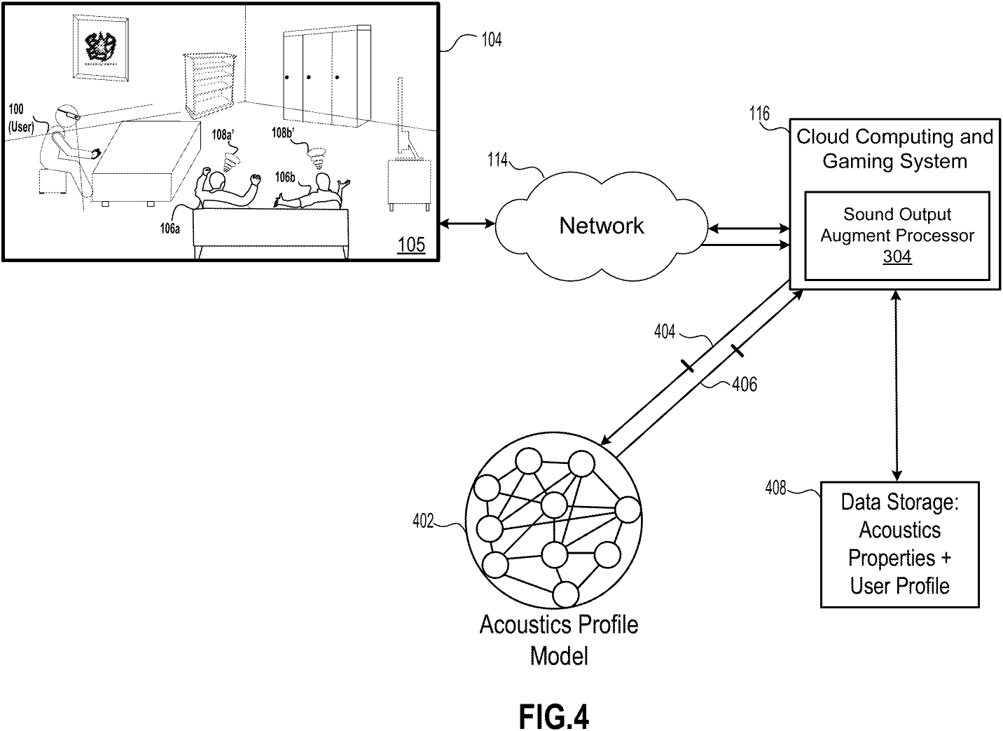

FIG. 4 illustrates an embodiment of a system for augmenting sound output 108 of virtual objects 106 in an AR scene using an acoustics profile model 402. As shown, the figure shows a method for augmenting the sound output of virtual objects which include using an acoustics profile model 402 that is configured to receive contextual data 404. In one embodiment, the contextual data 404 may include a variety of information associated with the context of the AR environment that the user is interacting in such as real-world space, real-world objects, virtual objects, contextual data regarding the interaction in the AR environment, etc. For example, the contextual data 404 may provide information describing all of the real-world objects 110 that are present in the real-world space 105 and information related to the interaction between the virtual characters and the AR user.

In one embodiment, the acoustics profile model 402 is configured to receive as input the contextual data 404 to predict an acoustics profile 406 associated with the real-world space 105. In some embodiments, other inputs that are not direct inputs may also be taken as inputs to the acoustics profile model 402. In one embodiment, the acoustics profile model 402 may also use a machine learning model that is used to identify the real-world objects 110 that are present in the real-world space 105 and the properties associated with the real-world objects 110. For example, the machine learning model can be used to identify that the AR user is sitting on a chair made of rubber and that its corresponding sound absorption coefficient is 0.05. Accordingly, the acoustics profile model 402 can be used to generate a prediction for the acoustics profile 406 of the real-world space which may include reflective sound and absorbed sound associated with the real-world objects. In some embodiments, the acoustics profile model 402 is configured to receive as inputs the acoustic measurements collected from the acoustic sensors 112 and the measurements collected form the microphone of the AR HMD 102. Using the noted inputs, the acoustics profile model 402 may also be used to identify patterns, similarities, and relationships between the inputs to generate a prediction for the acoustics profile 406. Over time, the acoustics profile model 402 can be further refined and the model can be trained to learn and accurately predict the acoustics profile 406 of a real-world space.

After generating a prediction for the acoustics profile 406 of the real-world space 105, the method flows to the cloud computing and gaming system 116 where the cloud computing and gaming system 116 is configured to process the acoustics profile 406. In one embodiment, the cloud computing and gaming system 116 may include a sound output augment processor 304 that is configured to identify the sound output 108 of the virtual objects in the AR scene 104. In some embodiments, using the acoustics profile 406 of the real-world space 105, the sound output augment processor 304 is configured to augment the sound output 108 based on the acoustics profile 406 in substantial real-time to produce the augmented sound output 108′ for transmission to the AR scene. Accordingly, the augmented sound output 108′ can be audible to the AR user 100 while the user is immersed in the AR environment and interacting with the virtual objects.

In some embodiments, the cloud computing and gaming system 116 can access a data storage 408 to retrieve data that can be used by the sound output augment processor 304 to augment the sound output 108. In one embodiment, the data storage 408 may include information related to the acoustic properties of the real-world objects such as the sound absorption coefficient of various materials. For example, using the sound absorption coefficient, the predicted acoustics profile 406 which includes a prediction of reflective sound and absorbed sound associated with real-world objects can be further adjusted to be more accurate. In other embodiments, the data storage 408 may include templates corresponding to the type of changes to be adjusted to the sound output 108 based on the acoustics profile 406 and the contextual data of the AR scene, e.g., intensity, pitch, volume, tone, etc.

In some embodiments, the data storage 408 may include a user profile of the user which can include preferences, interests, disinterests, etc. of the user. For example, the user profile may indicate when the user is immersed in the AR environment, the user likes to be fully disconnected from sounds originating from the real-world. Accordingly, using the user profile, the sound output augment processor 304 can generate an augmented sound output 108′ that excludes sound coming from friends, family, dogs, street traffic, and other sounds that may be present in the real-world space.

In one example, as shown in AR scene 104 illustrated in FIG. 4, the user 100 is shown interacting with virtual objects 106a-106b which are rendered as virtual characters. When the virtual characters project a voice output, the sound output augment processor 304 is configured to augment the voice output of the virtual characters in real-time using the predicted acoustics profile 406. In substantial real-time, the augmented sound output 108′ can be received by the AR user 100 via the AR HMD. The augmented sound output 108′ may be perceived by the AR user as if the virtual characters are in the real-world space as the user and that the sound is originating from a position where the virtual characters are located, e.g., sofa. In this way, a more realistic AR interaction with friends of the AR user can be achieved where the friends of the AR user can be rendered as virtual characters in the same real-world space of the AR user.

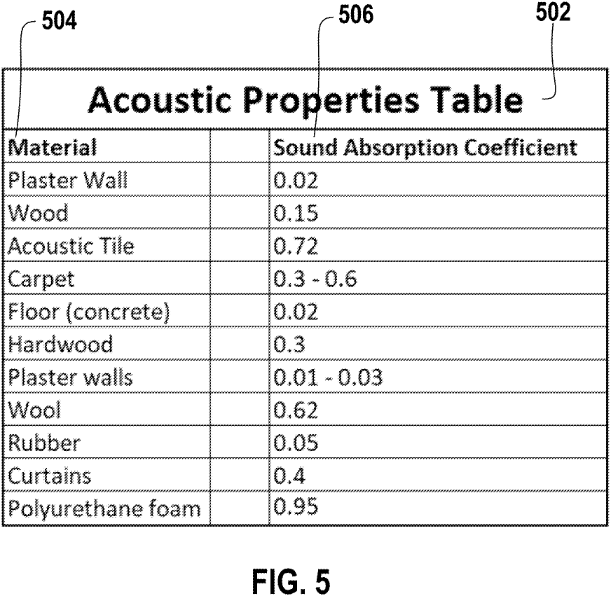

FIG. 5 illustrates an embodiment of an acoustics properties table 502 illustrating an example list of materials 504 and its corresponding sound absorption coefficient 506. In one embodiment, the acoustics properties table 502 can be stored in data storage 408 and accessed by the cloud computing and gaming system 116 for making updates to the predicted acoustics profile 406. As shown, the list of materials 504 include common material types such as wood, plaster walls, wool, rubber, and foam. In one embodiment, the sound absorption coefficient 506 for the respective material is used to evaluate the sound absorption efficiency of the material. The sound absorption coefficient is the ratio of absorbed sound intensity in an actual material to the incident sound intensity. The sound absorption coefficient 506 can measure an amount of sound that is absorbed into the material or an amount of sound that is reflected from the material. In one embodiment, the sound absorption coefficient can range between approximately 0 and 1. For example, when a material has a sound absorption coefficient value of ‘1,’ the sound is absorbed into the material rather than being reflected from the material. In another example, as illustrated in the acoustics properties table 502, since the absorption coefficient value for polyurethane foam (e.g., 0.95) is greater than the absorption coefficient value for plaster wall (e.g., 0.02), the polyurethane foam will absorb a greater amount of sound than the plaster wall. Accordingly, the acoustics properties table 502 can be used to make further adjustments to the acoustics profile 406 to improve its accuracy. In some embodiments, the absorption coefficient of materials can be changed dynamically based on changes in the type of materials or varying attributes of those materials. For example, if a surface is hardwood, the absorption coefficient could increase if the material is a rougher finish than if the hardwood were smooth and/or finish with high gloss. In other embodiments, the absorption coefficients can be adjusted based on feedback received from users, or based on a machine learning model that can adjust coefficients based on learned properties of different materials over time. Accordingly, it should be understood that the absorption coefficients are just examples and can vary depending on various conditions of the materials themselves or the environment in which the materials are located.

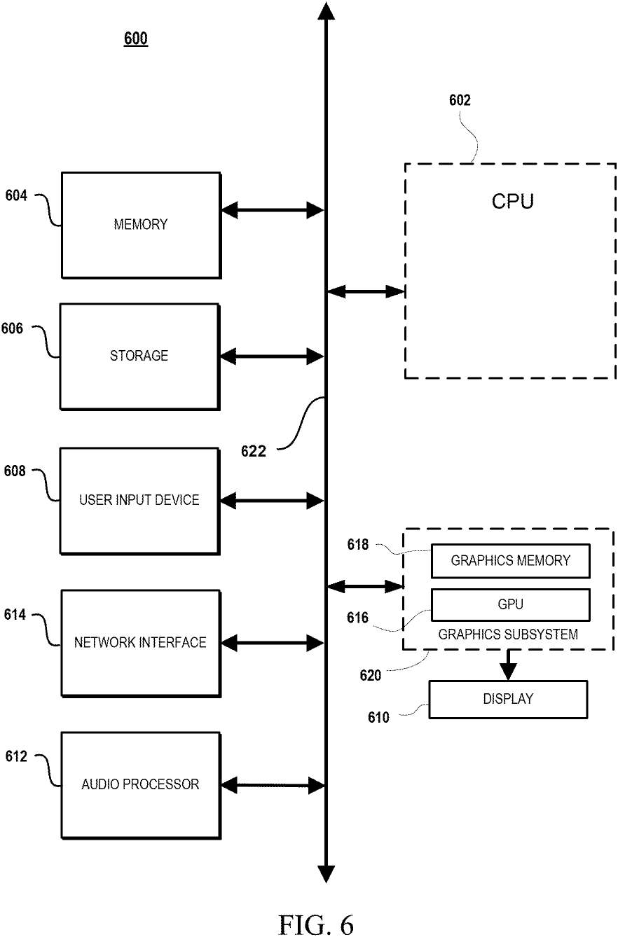

FIG. 6 illustrates components of an example device 600 that can be used to perform aspects of the various embodiments of the present disclosure. This block diagram illustrates a device 600 that can incorporate or can be a personal computer, video game console, personal digital assistant, a server or other digital device, suitable for practicing an embodiment of the disclosure. Device 600 includes a central processing unit (CPU) 602 for running software applications and optionally an operating system. CPU 602 may be comprised of one or more homogeneous or heterogeneous processing cores. For example, CPU 602 is one or more general-purpose microprocessors having one or more processing cores. Further embodiments can be implemented using one or more CPUs with microprocessor architectures specifically adapted for highly parallel and computationally intensive applications, such as processing operations of interpreting a query, identifying contextually relevant resources, and implementing and rendering the contextually relevant resources in a video game immediately. Device 600 may be a localized to a player playing a game segment (e.g., game console), or remote from the player (e.g., back-end server processor), or one of many servers using virtualization in a game cloud system for remote streaming of gameplay to clients.

Memory 604 stores applications and data for use by the CPU 602. Storage 606 provides non-volatile storage and other computer readable media for applications and data and may include fixed disk drives, removable disk drives, flash memory devices, and CD-ROM, DVD-ROM, Blu-ray, HD-DVD, or other optical storage devices, as well as signal transmission and storage media. User input devices 608 communicate user inputs from one or more users to device 600, examples of which may include keyboards, mice, joysticks, touch pads, touch screens, still or video recorders/cameras, tracking devices for recognizing gestures, and/or microphones. Network interface 614 allows device 600 to communicate with other computer systems via an electronic communications network, and may include wired or wireless communication over local area networks and wide area networks such as the internet. An audio processor 612 is adapted to generate analog or digital audio output from instructions and/or data provided by the CPU 602, memory 604, and/or storage 606. The components of device 600, including CPU 602, memory 604, data storage 606, user input devices 608, network interface 610, and audio processor 612 are connected via one or more data buses 622.

A graphics subsystem 620 is further connected with data bus 622 and the components of the device 600. The graphics subsystem 620 includes a graphics processing unit (GPU) 616 and graphics memory 618. Graphics memory 618 includes a display memory (e.g., a frame buffer) used for storing pixel data for each pixel of an output image. Graphics memory 618 can be integrated in the same device as GPU 608, connected as a separate device with GPU 616, and/or implemented within memory 604. Pixel data can be provided to graphics memory 618 directly from the CPU 602. Alternatively, CPU 602 provides the GPU 616 with data and/or instructions defining the desired output images, from which the GPU 616 generates the pixel data of one or more output images. The data and/or instructions defining the desired output images can be stored in memory 604 and/or graphics memory 618. In an embodiment, the GPU 616 includes 3D rendering capabilities for generating pixel data for output images from instructions and data defining the geometry, lighting, shading, texturing, motion, and/or camera parameters for a scene. The GPU 616 can further include one or more programmable execution units capable of executing shader programs.

The graphics subsystem 614 periodically outputs pixel data for an image from graphics memory 618 to be displayed on display device 610. Display device 610 can be any device capable of displaying visual information in response to a signal from the device 600, including CRT, LCD, plasma, and OLED displays. Device 600 can provide the display device 610 with an analog or digital signal, for example.

It should be noted, that access services, such as providing access to games of the current embodiments, delivered over a wide geographical area often use cloud computing. Cloud computing is a style of computing in which dynamically scalable and often virtualized resources are provided as a service over the Internet. Users do not need to be an expert in the technology infrastructure in the “cloud” that supports them. Cloud computing can be divided into different services, such as Infrastructure as a Service (IaaS), Platform as a Service (PaaS), and Software as a Service (SaaS). Cloud computing services often provide common applications, such as video games, online that are accessed from a web browser, while the software and data are stored on the servers in the cloud. The term cloud is used as a metaphor for the Internet, based on how the Internet is depicted in computer network diagrams and is an abstraction for the complex infrastructure it conceals.

A game server may be used to perform the operations of the durational information platform for video game players, in some embodiments. Most video games played over the Internet operate via a connection to the game server. Typically, games use a dedicated server application that collects data from players and distributes it to other players. In other embodiments, the video game may be executed by a distributed game engine. In these embodiments, the distributed game engine may be executed on a plurality of processing entities (PEs) such that each PE executes a functional segment of a given game engine that the video game runs on. Each processing entity is seen by the game engine as simply a compute node. Game engines typically perform an array of functionally diverse operations to execute a video game application along with additional services that a user experiences. For example, game engines implement game logic, perform game calculations, physics, geometry transformations, rendering, lighting, shading, audio, as well as additional in-game or game-related services. Additional services may include, for example, messaging, social utilities, audio communication, game play replay functions, help function, etc. While game engines may sometimes be executed on an operating system virtualized by a hypervisor of a particular server, in other embodiments, the game engine itself is distributed among a plurality of processing entities, each of which may reside on different server units of a data center.

According to this embodiment, the respective processing entities for performing the operations may be a server unit, a virtual machine, or a container, depending on the needs of each game engine segment. For example, if a game engine segment is responsible for camera transformations, that particular game engine segment may be provisioned with a virtual machine associated with a graphics processing unit (GPU) since it will be doing a large number of relatively simple mathematical operations (e.g., matrix transformations). Other game engine segments that require fewer but more complex operations may be provisioned with a processing entity associated with one or more higher power central processing units (CPUs).

By distributing the game engine, the game engine is provided with elastic computing properties that are not bound by the capabilities of a physical server unit. Instead, the game engine, when needed, is provisioned with more or fewer compute nodes to meet the demands of the video game. From the perspective of the video game and a video game player, the game engine being distributed across multiple compute nodes is indistinguishable from a non-distributed game engine executed on a single processing entity, because a game engine manager or supervisor distributes the workload and integrates the results seamlessly to provide video game output components for the end user.

Users access the remote services with client devices, which include at least a CPU, a display and I/O. The client device can be a PC, a mobile phone, a netbook, a PDA, etc. In one embodiment, the network executing on the game server recognizes the type of device used by the client and adjusts the communication method employed. In other cases, client devices use a standard communications method, such as html, to access the application on the game server over the internet.

It should be appreciated that a given video game or gaming application may be developed for a specific platform and a specific associated controller device. However, when such a game is made available via a game cloud system as presented herein, the user may be accessing the video game with a different controller device. For example, a game might have been developed for a game console and its associated controller, whereas the user might be accessing a cloud-based version of the game from a personal computer utilizing a keyboard and mouse. In such a scenario, the input parameter configuration can define a mapping from inputs which can be generated by the user’s available controller device (in this case, a keyboard and mouse) to inputs which are acceptable for the execution of the video game.

In another example, a user may access the cloud gaming system via a tablet computing device, a touchscreen smartphone, or other touchscreen driven device. In this case, the client device and the controller device are integrated together in the same device, with inputs being provided by way of detected touchscreen inputs/gestures. For such a device, the input parameter configuration may define particular touchscreen inputs corresponding to game inputs for the video game. For example, buttons, a directional pad, or other types of input elements might be displayed or overlaid during running of the video game to indicate locations on the touchscreen that the user can touch to generate a game input. Gestures such as swipes in particular directions or specific touch motions may also be detected as game inputs. In one embodiment, a tutorial can be provided to the user indicating how to provide input via the touchscreen for gameplay, e.g., prior to beginning gameplay of the video game, so as to acclimate the user to the operation of the controls on the touchscreen.

In some embodiments, the client device serves as the connection point for a controller device. That is, the controller device communicates via a wireless or wired connection with the client device to transmit inputs from the controller device to the client device. The client device may in turn process these inputs and then transmit input data to the cloud game server via a network (e.g., accessed via a local networking device such as a router). However, in other embodiments, the controller can itself be a networked device, with the ability to communicate inputs directly via the network to the cloud game server, without being required to communicate such inputs through the client device first. For example, the controller might connect to a local networking device (such as the aforementioned router) to send to and receive data from the cloud game server. Thus, while the client device may still be required to receive video output from the cloud-based video game and render it on a local display, input latency can be reduced by allowing the controller to send inputs directly over the network to the cloud game server, bypassing the client device.

In one embodiment, a networked controller and client device can be configured to send certain types of inputs directly from the controller to the cloud game server, and other types of inputs via the client device. For example, inputs whose detection does not depend on any additional hardware or processing apart from the controller itself can be sent directly from the controller to the cloud game server via the network, bypassing the client device. Such inputs may include button inputs, joystick inputs, embedded motion detection inputs (e.g., accelerometer, magnetometer, gyroscope), etc. However, inputs that utilize additional hardware or require processing by the client device can be sent by the client device to the cloud game server. These might include captured video or audio from the game environment that may be processed by the client device before sending to the cloud game server. Additionally, inputs from motion detection hardware of the controller might be processed by the client device in conjunction with captured video to detect the position and motion of the controller, which would subsequently be communicated by the client device to the cloud game server. It should be appreciated that the controller device in accordance with various embodiments may also receive data (e.g., feedback data) from the client device or directly from the cloud gaming server.

It should be understood that the various embodiments defined herein may be combined or assembled into specific implementations using the various features disclosed herein. Thus, the examples provided are just some possible examples, without limitation to the various implementations that are possible by combining the various elements to define many more implementations. In some examples, some implementations may include fewer elements, without departing from the spirit of the disclosed or equivalent implementations.

Embodiments of the present disclosure may be practiced with various computer system configurations including hand-held devices, microprocessor systems, microprocessor-based or programmable consumer electronics, minicomputers, mainframe computers and the like. Embodiments of the present disclosure can also be practiced in distributed computing environments where tasks are performed by remote processing devices that are linked through a wire-based or wireless network.

Although the method operations were described in a specific order, it should be understood that other housekeeping operations may be performed in between operations, or operations may be adjusted so that they occur at slightly different times or may be distributed in a system which allows the occurrence of the processing operations at various intervals associated with the processing, as long as the processing of the telemetry and game state data for generating modified game states and are performed in the desired way.

One or more embodiments can also be fabricated as computer readable code on a computer readable medium. The computer readable medium is any data storage device that can store data, which can be thereafter be read by a computer system. Examples of the computer readable medium include hard drives, network attached storage (NAS), read-only memory, random-access memory, CD-ROMs, CD-Rs, CD-RWs, magnetic tapes and other optical and non-optical data storage devices. The computer readable medium can include computer readable tangible medium distributed over a network-coupled computer system so that the computer readable code is stored and executed in a distributed fashion.

In one embodiment, the video game is executed either locally on a gaming machine, a personal computer, or on a server. In some cases, the video game is executed by one or more servers of a data center. When the video game is executed, some instances of the video game may be a simulation of the video game. For example, the video game may be executed by an environment or server that generates a simulation of the video game. The simulation, on some embodiments, is an instance of the video game. In other embodiments, the simulation maybe produced by an emulator. In either case, if the video game is represented as a simulation, that simulation is capable of being executed to render interactive content that can be interactively streamed, executed, and/or controlled by user input.

Although the foregoing embodiments have been described in some detail for purposes of clarity of understanding, it will be apparent that certain changes and modifications can be practiced within the scope of the appended claims. Accordingly, the present embodiments are to be considered as illustrative and not restrictive, and the embodiments are not to be limited to the details given herein, but may be modified within the scope and equivalents of the appended claims.

What is claimed is:

1. A method for augmenting voice output of a virtual character in an augmented reality (AR) scene, comprising:
examining, by a server , the AR scene, said AR scene includes a real-world space and the virtual character overlaid into the real-world space at a location, the real-world space includes a plurality of real-world objects present in the real-world space;
processing, by the server, to identify an acoustics profile associated with the real-world space, said acoustics profile including reflective sound and absorbed sound associated with real-world objects proximate to the location of the virtual character; and
processing, by the server, the voice output by the virtual character while interacting in the AR scene, the processing is configured to augment the voice output based on the acoustics profile of the real-world space, the augmented voice output being audible by an AR user viewing the virtual character in the real-world space.

2. The method of claim 1, wherein the acoustics profile further includes reverberations and echoes from a position in the real-world space.

3. The method of claim 1, wherein the reflective sound and absorbed sound associated with the real-world objects has a magnitude and direction, said magnitude and said direction corresponds to a sound intensity level of a sound component that is projected in the real-world space.

4. The method of claim 1, wherein the real-world objects are associated with a sound absorption coefficient, said sound absorption coefficient is used to determine an amount of sound that is absorbed into the real-world objects or an amount of sound that is reflected from the real-world objects.

5. The method of claim 1, wherein the identification of the acoustics profile includes a calibration process using an AR HMD of the AR user to determine the acoustics profile the real-world space, said calibration process includes capturing acoustic characteristics at different positions in the real-world space using a microphone of the AR HMD.

6. The method of claim 1, wherein the identification of the acoustics profile includes capturing acoustic measurements using a plurality of acoustic sensors that are placed at different positions in the real-world space.

7. The method of claim 6, wherein the captured acoustic measurements includes reverberations, magnitude and direction of the reflective sound, magnitude and direction and of the absorbed sound, or a combination of two or more thereof.

8. The method of claim 1, wherein said overlay of the virtual character into the real-world space causes a size and shape of the virtual character to be scaled consistently with a size of the real-world objects in the AR scene.

9. The method of claim 1, wherein the augmented voice output provides the AR user with a perception of the augmented voice output being projected from the location proximate to the virtual character.

10. The method of claim 1, further comprising:
modifying, by the server, the augmented voice output to remove selected sound sources based on one or more preferences of the AR user; and
sending, by the server, the modified augmented voice output to a client device of the AR user interacting in the AR scene.

11. The method of claim 10, wherein the client device is an AR HMD or surround sound speakers that are present in the real-world space.

12. The method of claim 1, wherein the acoustics profile is identified in part using an acoustics profile model that is trained over time to predict the reflective sound, the absorbed sound, and other acoustic characteristics at different positions in the real-world space.

13. The method of claim 1, wherein the acoustics profile is identified based on processing contextual data and acoustic measurements collected from an AR HMD of the AR user through an acoustics profile model, the acoustics profile model is configured to identify relationships between the contextual data and the acoustic measurements to generate a prediction for the acoustics profile.

14. A system for augmenting sound output of a virtual object in an augmented reality (AR) scene, the system comprising:
an AR head mounted display (HMD), said AR HMD includes a display for rendering the AR scene, said AR scene includes a real-world space and the virtual object overlaid into the real-world space at a location, the real-world space includes a plurality of real-world objects present in the real-world space; and
a processing unit associated with the AR HMD for identifying an acoustics profile associated with the real-world space, said acoustics profile including reflective sound and absorbed sound associated with real-world objects proximate to the location of the virtual object;
wherein the processing unit is configured to process the sound output by the virtual object while interacting in the AR scene, said processing unit is configured to augment the sound output based on the acoustics profile of the real-world space, the augmented sound output being audible by an AR user viewing the virtual object in the real-world space.

15. The system of claim 14, wherein the acoustics profile further includes reverberations from a position in the real-world space.

16. The system of claim 14, wherein the reflective sound and the absorbed sound associated with the real-world objects has a magnitude and direction, said magnitude and said direction corresponds to a sound intensity level of a sound source that is projected in the real-world space.

17. The system of claim 14, wherein the real-world objects are associated with a sound absorption coefficient, said sound absorption coefficient is used to determine an amount of sound that is absorbed into the real-world objects or an amount of sound that is reflected from the real-world objects.

18. The system of claim 14, wherein said overlay of the virtual object into the real-world space causes a size and shape of the virtual object to be scaled consistently with a size of the real-world objects in the AR scene.

19. The system of claim 14, wherein the acoustics profile is identified in part using an acoustics profile model that is trained over time to predict the reflective sound, the absorbed sound, and other acoustic characteristics at different positions in the real-world space.

20. The system of claim 14, wherein the augmented sound output is further processed to eliminate specific sounds based on one or more preferences of the AR user.

21. The system of claim 14, wherein the augmented sound output is further processed to replace the augmented sound output with an alternate sound based on one or more preferences of the AR user.
